(19) United States
(12) Patent Application Publication
(10) Pub. No.: US 2023/0221483 A1
(43) Pub. Date: Jul. 13, 2023

(54) Light source module and display device

(71) Applicants: NANO PRECISION (SUZHOU) CO.,LTD., Suzhou (CN); Nano Precision Taiwan Limited, HSINCHU COUNTY (CN)

(72) Inventors: WEN-YEN CHIU, HSINCHU COUNTY (TW); HSIN-WEI CHEN, HSINCHU COUNTY (TW); CHAO-HUNG WENG, HSINCHU COUNTY (TW); MING-DAH LIU, HSINCHU COUNTY (TW); YUE-FENG YANG, Suzhou (CN)

(21) Appl. No.: 18/092,949

(22) Filed: Jan. 4, 2023

(30) Foreign Application Priority Data
Jan. 11, 2022 (CN) 202220060703.3

(51) Int. Cl. F21V 8/00

(52) U.S. Cl. CPC G02B 6/0053; G02B 6/0043

(57) ABSTRACT

A light source module includes a light guide plate, light emitting elements, a prism sheet and a reflective sheet. The light guide plate has a light incident surface, a light emitting surface and a bottom surface. The light incident surface is connected to the light emitting surface and the bottom surface. The light emitting elements are disposed beside the light incident surface. The prism sheet is disposed beside the light emitting surface and includes prism pillars. The reflective sheet is disposed beside the bottom surface and includes a substrate and pyramidal structures. The substrate has a reflective surface. The pyramidal structures are disposed on the reflective surface. Each pyramidal structure has optical side surfaces. Each optical side surface has a bottom edge connected to the reflective surface. One optical side surface faces the light incident surface, and the respective bottom edge is parallel to the light incident surface.

### CROSS-REFERENCE TO RELATED APPLICATION

This application claims the priority benefit of China application (202220060703.3), filed on Jan. 11, 2022. The entirety of the above-mentioned patent application is hereby incorporated by reference herein and made a part of this specification.

### FIELD OF THE INVENTION

The invention relates to a light source module, and more particularly to a light source module that can be used in a display device and a display device using the light source module.

### BACKGROUND OF THE INVENTION

A liquid crystal display device includes a liquid crystal display panel and a backlight module. Because the liquid crystal display panel itself does not emit light, it is necessary to rely on the backlight module to provide a display light source to the liquid crystal display panel. Therefore, the main function of the backlight module is to provide a display light source with high luminance and high uniformity.

Backlight modules can be divided into edge-type backlight modules and direct-type backlight modules. In a general edge-type backlight module, according to Snellen's law, light will deviate from the normal direction when the light exits from the light emitting surface of a light guide plate (i.e., light enters the optically sparser medium from the optically denser medium). That is, the area where the light energy is concentrated will deviate from the center, making it difficult for the backlight module to achieve the effect of forward light output.

Therefore, the effect of adjusting the light exit angle is limited in the edge-type backlight module using only the light guide plate.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

This invention provides a light source module, which can adjust the light exit angle of light and improve the effect of forward light output.

This invention provides a display device, which can improve the brightness uniformity of a display image.

Other advantages and objects of the invention may be further illustrated by the technical features broadly embodied and described as follows.

In order to achieve one or a portion of or all of the objects or other objects, an embodiment of the invention provides a light source module, which includes a light guide plate, a plurality of light emitting elements, a prism sheet and a reflective sheet. The light guide plate has a light incident surface, a light emitting surface and a bottom surface opposite to the light emitting surface. The light incident surface is connected to the light emitting surface and the bottom surface. The light emitting elements are disposed beside the light incident surface and configured to emit light to the light incident surface. The prism sheet is disposed beside the light emitting surface and includes a plurality of prism pillars. The reflective sheet is disposed beside the bottom surface and includes a substrate and a plurality of pyramidal structures. The substrate has a reflective surface facing the bottom surface. The pyramidal structures are disposed on the reflective surface. Each of the pyramidal structures has a plurality of optical side surfaces. Each of the optical side surfaces has a bottom edge. The bottom edge is connected to the reflective surface. One of the optical side surfaces of each of the pyramidal structures faces the light incident surface, and the bottom edge thereof is parallel to the light incident surface.

In order to achieve one or a portion of or all of the objects or other objects, an embodiment of the invention provides a display device, which includes a display panel and the aforementioned light source module. The display panel is disposed on a light emitting side of the light source module.

In the light source module of the embodiment of the invention, the reflective sheet includes a plurality of pyramidal structures, and one of the plurality optical side surfaces of each pyramidal structure faces the light incident surface. Because the optical side surface of the pyramidal structure is inclined relative to the light incident surface, light is reflected back to the light guide plate by the inclined optical side surface when the light exits from the bottom surface and is transmitted to the reflective sheet, wherein the reflection angle is changed by the inclined optical side surface. With the setting of the pyramidal structures, the light exit angle of the light exiting from the light emitting surface can be adjusted. In addition, the prism sheet in the light source module of the embodiment of the invention can further converge and concentrate the adjusted light to form a uniform surface light source. Therefore, compared with the conventional light source module using a reflective sheet without a structure, the light source module of the embodiment of the invention can improve the effect of forward light output. Because the display device of the embodiment of the invention uses the aforementioned light source module, the light field energy of the output light can be adjusted to a better light field distribution, thereby improving the brightness uniformity of the display image.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional diagram of a light source module according to an embodiment of the invention;

FIG. 2 is a schematic cross-sectional view of the light source module, taken along line B-B′ in FIG. 1;

FIG. 3 is a schematic three-dimensional diagram of a pyramidal structure according to an embodiment of the invention;

FIG. 4 is a schematic three-dimensional diagram of a light source module according to another embodiment of the invention;

FIG. 5 is a schematic three-dimensional diagram of a light source module according to another embodiment of the invention;

FIG. 6 is a schematic diagram of a reflective sheet according to another embodiment of the invention;

FIG. 7 is a schematic diagram of a reflective sheet according to another embodiment of the invention; and

FIG. 8 is a schematic block diagram of a display device according to an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

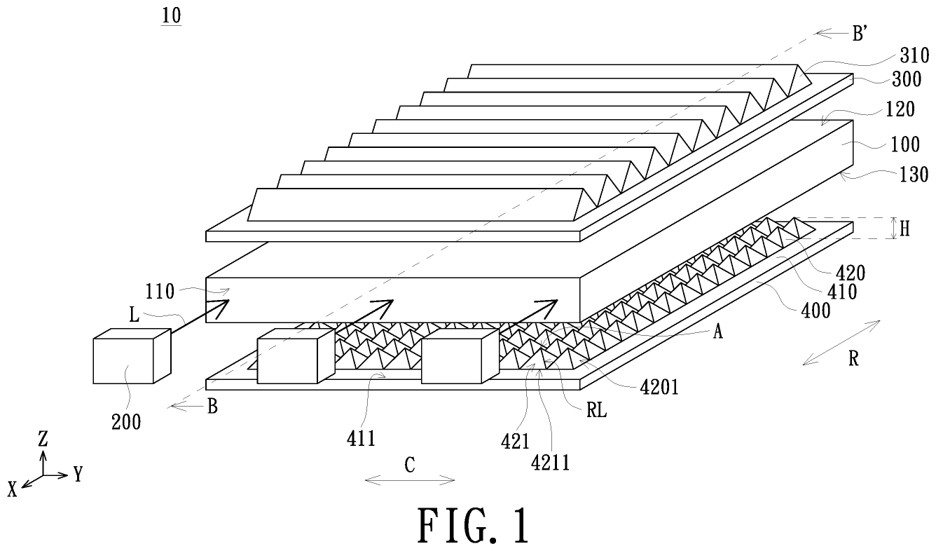

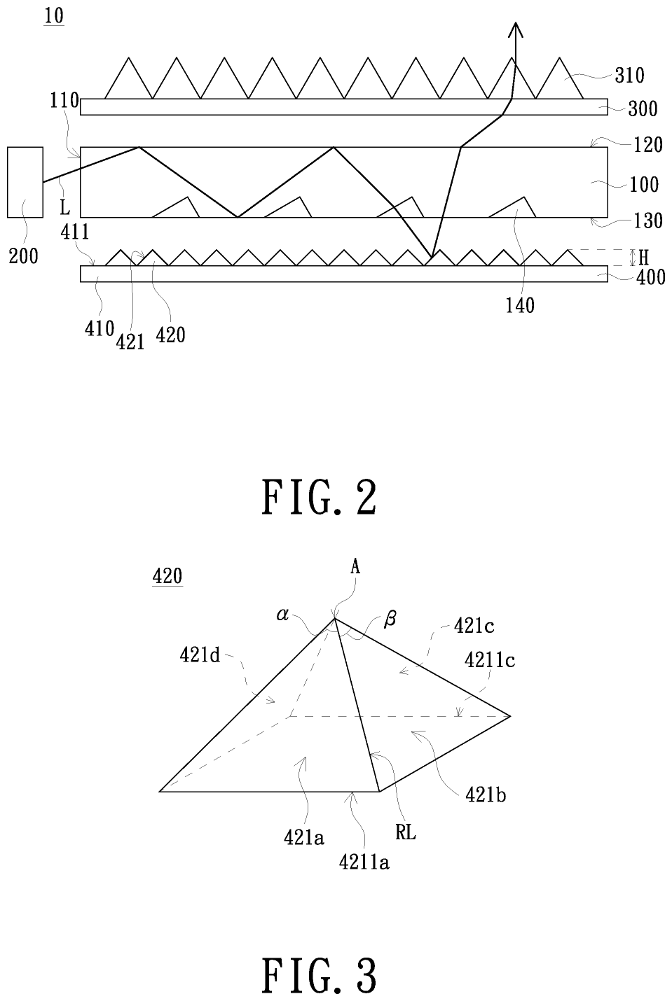

FIG. 1 is a schematic three-dimensional diagram of a light source module according to an embodiment of the invention. FIG. 2 is a schematic cross-sectional view of the light source module, taken along line B-B′ in FIG. 1. FIG. 3 is a schematic three-dimensional diagram of a pyramidal structure according to an embodiment of the invention. Referring to FIGS. 1 and 2, the light source module 10 of this embodiment includes a light guide plate 100, a plurality of light emitting elements 200, a prism sheet 300 and a reflective sheet 400. The light guide plate 100 has a light incident surface 110, a light emitting surface 120 and a bottom surface 130 opposite to the light emitting surface 120. The light incident surface 110 is connected to the light emitting surface 120 and the bottom surface 130. The plurality of light emitting elements 200 are disposed beside the light incident surface 110 and are configured to emit light L to the light incident surface 110. The prism sheet 300 is disposed beside the light emitting surface 120 and includes a plurality of prism pillars 310. The reflective sheet 400 is disposed beside the bottom surface 130 and includes a substrate 410 and a plurality of pyramidal structures 420. The substrate 410 has a reflective surface 411 facing the bottom surface 130. The plurality of pyramidal structures 420 are disposed on the reflective surface 411.

Each pyramidal structure 420 has a plurality of optical side surfaces 421, each optical side surface 421 has a bottom edge 4211, and the bottom edges 4211 are connected to the reflective surface 411. One of the optical side surfaces 421 of each pyramidal structure 420 faces the light incident surface 110, and the bottom edge 4211 of the optical side surface 421 facing the light incident surface 110 is parallel to the light incident surface 110. That is, the optical side surface 421 of each pyramidal structure 420 facing the light incident surface 110 forwardly faces the light incident surface 110, and only one of the plurality of optical side surfaces 421 of each pyramidal structure 420 forwardly faces the light incident surface 110, and the other optical side surfaces 421 face away from the light incident surface 421 or non-forwardly face the light incident surface 110 in a manner in which their bottom edges 4211 are non-parallel to the light incident surface 110. It should be noted that because the top of the pyramidal structure 420 is a vertex and the bottom is a polygonal shape, the optical side surfaces 421 are actually relatively inclined to the reflective surface 411. In addition, taking FIG. 1 as an example, the optical side surface 421 forwardly facing the light incident surface 110 forms an acute angle with the YZ plane and the XY plane respectively. In this embodiment, the light incident surface 110 is parallel to the YZ plane, and the reflective surface 411 is parallel to the XY plane. Therefore, the optical side surface 421 forwardly facing the light incident surface 110 is also relatively inclined to the light incident surface 110, in addition to being relatively inclined to the reflective surface 411.

In this embodiment, the pyramidal structure 420 is, for example, a quadrangular pyramid structure, but the invention is not limited thereto. In other embodiments, the pyramidal structure 420 may be a triangular pyramid structure, a pentagonal pyramid structure, a hexagonal pyramid structure, etc. Hereinafter, the features of the pyramidal structure 420 will be described in detail by using the quadrangular pyramid structure of this embodiment. Referring to FIGS. 1 and 3, the quadrangular pyramid structure 420 has four optical side surfaces 421 and is a regular quadrangular pyramid structure. The optical side surfaces 421 include a first optical side surface 421a, a second optical side surface 421b, a third optical side surface 421c and a fourth optical side surface 421d. The first optical side surface 421a is opposite to the third optical side surface 421c. The second optical side surface 421b is opposite to the fourth optical side surface 421d. The bottom edge 4211a of the first optical side surface 421a and the bottom edge 4211c of the third optical side surface 421c are parallel to the light incident surface 110, the first optical side surface 421a forwardly faces the light incident surface 110, and the third optical side surface 421c faces away from the light incident surface 110.

The first optical side surface 421a and the third optical side surface 421c each have a first vertex angle α (only the first vertex angle α of the first optical side surface 421a is shown in FIG. 3). The second optical side surface 421b and the fourth optical side surface 421d each have a second vertex angle β (only the second vertex angle β of the second optical side surface 421b is shown in FIG. 3). The first vertex angle α is equal to the second vertex angle β when the quadrangular pyramid structure 420 is a regular quadrangular pyramid structure, and the angular range is 90° to 150°. On the contrary, the first vertex angle α is different from the second vertex angle β when the quadrangular pyramid structure 420 is a non-regular quadrangular pyramid structure, wherein the angular range of the first vertex angle α is 5° to 175°, and the angular range of the second vertex angle β is 5° to 175°.

In this embodiment, each pyramidal structure 420 (quadrangular pyramid structure) further has an apex A, and the “apex” mentioned here is only used to represent the top of the pyramidal structure 420 and is not used to limit the shape of the top of the pyramidal structure 420. Specifically, the shape of the apex A includes, for example, a point shape, a plane shape and an arc shape. When the shape of the apex A is a plane shape or an arc shape, the wear of the pyramidal structure 420 can be reduced, and the possible damage caused by the bottom surface 130 of the light guide plate 100 contacting the pyramidal structure 420 can be reduced, which affects the transmission path of light. In addition, any two adjacent optical side surfaces 421 are connected to each other to form a ridgeline RL of each pyramidal structure 420, and the shape of the ridgeline RL includes, for example, a line shape, a plane shape and an arc shape. The aforementioned effect of reducing wear or damage can also be achieved when the shape of the ridgeline RL is a plane shape or an arc shape.

Refer to FIGS. 1 and 2 again. In this embodiment, the heights H of the plurality of pyramidal structures 420 in the direction perpendicular to the reflective surface 411 are the same, but the invention is not limited thereto. In another embodiment of the plurality of pyramidal structures 420, the heights H of at least some of the pyramidal structures 420 are different. By designing the heights H to be different, the contact area between the plurality of pyramidal structures 420 and the bottom surface 130 is reduced, thereby reducing the adsorption between the light guide plate 100 and the reflective sheet 400.

In this embodiment, the plurality of pyramidal structures 420 may be made of, for example, a light reflective material, such as a metal material or a mirror material, but a white reflective material is avoided. When the light L exits from the bottom surface 130 of the light guide plate 100 and is transmitted to the optical side surfaces 421 of the plurality of pyramidal structures 420, the light is directly reflected back to the light guide plate 100 as shown in FIG. 2. The reason for not using the white reflective material is that it also diffuses the light L when reflecting the light L, thereby reducing the effect of adjusting the angle of the light L. Alternatively, the plurality of pyramidal structures 420 may, for example, also be light-transmitting, that is, the pyramidal structures 420 are made of a light-transmitting material. When the light L exits from the bottom surface 130 of the light guide plate 100 and is transmitted to the optical side surfaces 421, the light L is refracted and reflected back to the light guide plate 100 by the reflective surfaces 411. No matter which above-mentioned method is adopted, the pyramidal structure 420 can achieve the effect of adjusting the transmission path of the light L.

In this embodiment, the plurality of pyramidal structures 420 are, for example, arranged in an array on the reflective surface 411, but the invention is not limited thereto. Specifically, the plurality of pyramidal structures 420 include a plurality of pyramidal structure columns 4201 arranged in parallel along the row direction R. Each pyramidal structure column 4201 has a part of the pyramidal structures 420 (a partial number of the plurality of pyramidal structures 420) arranged along the column direction C. That is, it can be seen that the plurality of pyramidal structure columns 4201 extend along the column direction C and are arranged along the row direction R. In this embodiment, it is taken as an example that the row direction R is perpendicular to the column direction C, and the row direction R is perpendicular to the light incident surface 110, but the invention is not limited thereto. In addition, in this embodiment, any two adjacent pyramidal structures 420 are connected to each other without a distance, the invention is not limited thereto. In another embodiment, there may be a distance between any two adjacent pyramidal structures 420. It should be noted that FIG. 1 is intended to illustrate the arrangement of the plurality of pyramidal structures 420, and the quantity of the plurality of pyramidal structures 420 is only for illustration, and the invention is not limited thereto.

In this embodiment, the plurality of light emitting elements 200 are, for example, light emitting diodes (LEDs), but the invention is not limited thereto. The light emitting elements 200 may also be other types of light source components, such as light tubes, and the invention does not limit the types of light sources. In addition, the quantity of the plurality of light emitting elements 200 in FIG. 1 is only for illustration, and the invention does not particularly limit the quantity of the light emitting elements 200.

After the angle adjustment of the pyramidal structures 420, the light L is transmitted back to the light guide plate 100 and exits from the light emitting surface 120. With the setting of the prism sheet 300, the adjusted light L can be further converged and concentrated to form a uniform surface light source. In this embodiment, the plurality of prism pillars 310 are arranged on the side of the prism sheet 300 facing away from the light guide plate 100 as an example, but the invention is not limited thereto. In addition, the plurality of prism pillars 310 in FIG. 1 are, for example, arranged along the row direction R and extend along the column direction C, but the invention does not particularly limit the arrangement direction of the plurality of prism pillars 310. For example, the plurality of prism pillars 310 may be arranged along the column direction C and extend along the row direction R. Alternatively, the arrangement direction of the plurality of prism pillars 310 may form an included angle with the bottom edge 4211 of the optical side surface 421 facing the light incident surface 110, and the angular range is 0° to 180°. The embodiment in which the arrangement direction of the plurality of prism pillars 310 is non-parallel or perpendicular to the bottom edge 4211 can also reduce the light interference fringes. Similar to the light emitting elements 200, the quantity of the plurality of prism pillars 310 in FIG. 1 is only for illustration, and the invention does not particularly limit the quantity of the prism pillars 310. The aforementioned features of the prism sheet 300 can be adjusted according to design requirements to make the light L achieve a better light-emitting effect.

In the light source module 10 of this embodiment, the reflective sheet 400 includes a plurality of pyramidal structures 420, and one of the plurality optical side surfaces 421 of each pyramidal structure 420 forwardly faces the light incident surface 110. Because the optical side surface 421 of the pyramidal structure 420 is inclined relative to the light incident surface 110, the light L is reflected back to the light guide plate 100 by the inclined optical side surface 421 when the light L exits from the bottom surface 130 and is transmitted to the reflective sheet 400, wherein the reflection angle is changed by the inclined optical side surface 421. With the setting of the pyramidal structures 420, the light exit angle of the light L exiting from the light emitting surface 120 can be adjusted. In addition, the prism sheet 300 in the light source module 10 of this embodiment can further converge and concentrate the adjusted light L to form a uniform surface light source. Therefore, compared with the conventional light source module using a reflective sheet without a structure, the light source module 10 of this embodiment can improve the effect of forward light output.

In this embodiment, the light guide plate 100 further includes, for example, a plurality of diffusion microstructures 140 disposed on the bottom surface 130. The diffusion microstructures 140 may be dots or other microstructures capable of diffusing the light L. The diffusion microstructures 140 can make the light L entering the light guide plate 100 from the light incident surface 110 be totally reflected in the light guide plate 100 and then exit toward the light emitting surface 120 or the reflective sheet 400. The distribution density of the diffusion microstructures 140 can be adjusted according to different design requirements, which is not particularly limited in the invention.

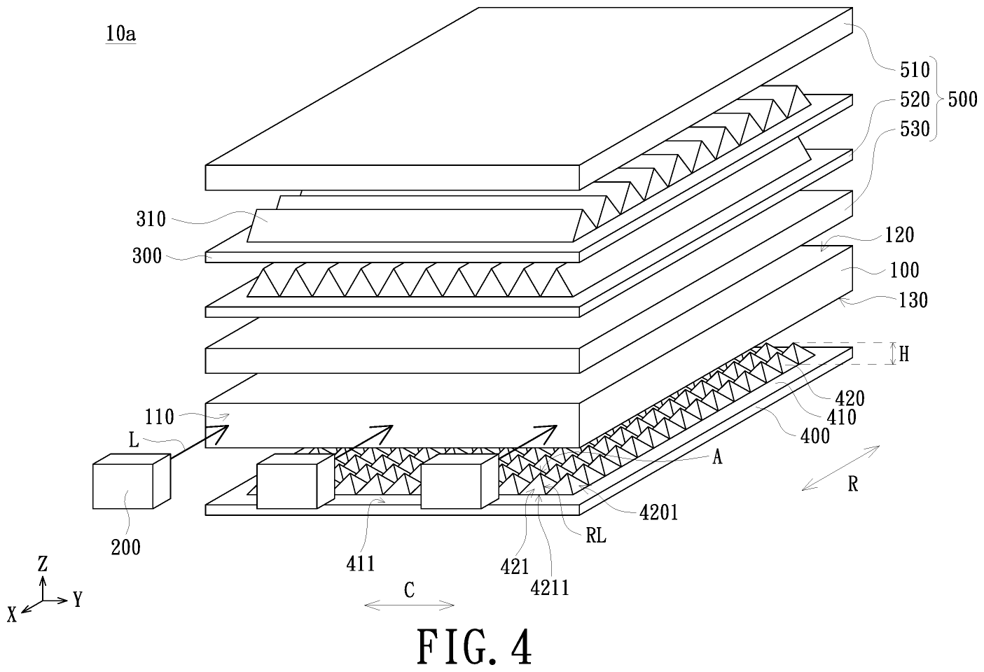

FIG. 4 is a schematic three-dimensional diagram of a light source module according to another embodiment of the invention. Referring to FIG. 4, the structure and advantages of the light source module 10a of this embodiment are similar to those of the light source module 10, and only the main differences in structures will be described below. The light source module 10a of this embodiment further includes an optical film set 500 disposed beside the light emitting surface 120. The optical film set 500 includes at least one optical film, and the optical film set 500 further includes a prism sheet 300. The at least one optical film of the optical film set 500 is, for example, a polarized brightness enhancement film, a diffusion film, a prism sheet or a composite prism sheet, etc., but the invention is not limited thereto. The invention does not limit the quantity of the at least one optical film, which can be one or more. In this embodiment, three optical films 510, 520 and 530 are used as an example. The prism sheet 300 may be disposed between the light guide plate 100 and the at least one optical film, or the at least one optical film may be disposed between the prism sheet 300 and the light guide plate 100, or the prism sheet 300 is disposed between the plurality of optical films when the quantity of the at least one optical film is plural. In addition, the optical films 510, 520 and 530 may be selected from different types according to the different functions of the optical films. For example, in FIG. 4, the optical film 510 is an upper diffusion sheet, the optical film 520 is a lower prism sheet, and the optical film 530 is a lower diffusion sheet. The arrangement direction of the plurality of prism pillars 310 is perpendicular to the arranging direction the plurality of prism pillars of the optical film 520. It should be noted that the aforementioned example is only one of the preferred embodiments of the invention, and the invention is not limited thereto.

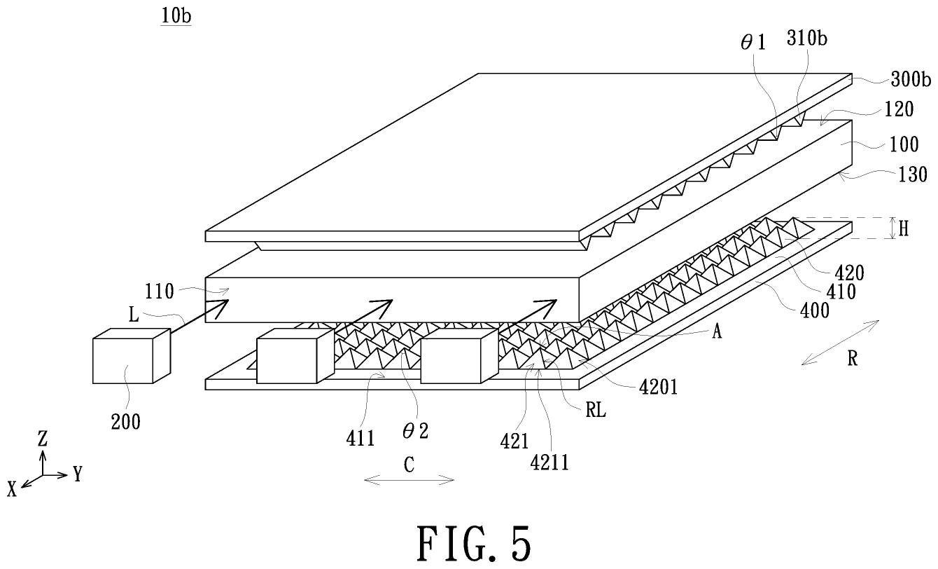

FIG. 5 is a schematic three-dimensional diagram of a light source module according to another embodiment of the invention. Referring to FIG. 5, the structure and advantages of the light source module 10b of this embodiment are similar to those of the light source module 10, and only the main differences in structures will be described below. In the light source module 10b of this embodiment, the plurality of prism pillars 310b of the prism sheet 300b are the light emitting surface 120 facing the light guide plate 100, that is, the prism sheet 300b is an inverse prism sheet. In a preferred embodiment of this embodiment, each prism pillar 310b has a prism vertex angle θ1, and the angular range of the prism vertex angle θ1 is, for example, 75° to 85°. Each optical side surface 421 has a vertex angle θ2, and the angular range of the vertex angle θ2 is, for example, 70° to 170°. The light source module 10b of this embodiment can have a better effect of forward light output under the above angle adjustment. Alternatively, in another preferred embodiment of this embodiment, the angular range of the prism vertex angle θ1 is, for example, 150° to 170°, and the angular range of the vertex angle θ2 is, for example, 95° to 160°.

The plurality of pyramidal structures 420 in FIG. 1 are arranged in an array on the reflective surface 411, but the invention is not limited thereto. According to different design requirements, the plurality of pyramidal structures 420 may be randomly distributed on the reflective surface 411 or arranged on the reflective surface 411 in other forms, which will be described in different embodiments below. FIG. 6 is a schematic diagram of a reflective sheet according to another embodiment of the invention. The structure and advantages of the reflective sheet 400a of this embodiment are similar to those of the reflective sheet 400, wherein the plurality of pyramidal structures 420 include a plurality of pyramidal structure columns 4201 arranged in parallel along the row direction R, and each pyramidal structure column 4201 has a part of the pyramidal structures 420 (a partial number of the plurality of pyramidal structures 420) arranged along the column direction C, and the row direction R is perpendicular to the column direction C. Only the main differences in structures will be described below. In the reflective sheet 400a of this embodiment, each pyramidal structure 420 has an apex A, and there is, for example, a distance d between any two adjacent pyramidal structures 420. The midpoint of the distance d between any two adjacent pyramidal structures 420 in each pyramidal structure column 4201 corresponds to the apex A of one of the part of the pyramidal structures 420 in another adjacent pyramidal structure column 4201. In other words, the quadrilateral shape formed by connecting the vertices A of any four adjacent pyramidal structures 420 in the plurality of pyramidal structures 420 is a parallelogram or a rhombus. In addition, there may be no distance d between any two adjacent pyramidal structures 420, and the arrangement pattern is changed to that the connection between any two adjacent pyramidal structures 420 in each pyramidal structure column 4201 corresponds to the apex A of one of the part of the pyramidal structures 420 in another adjacent pyramidal structure column 4201.

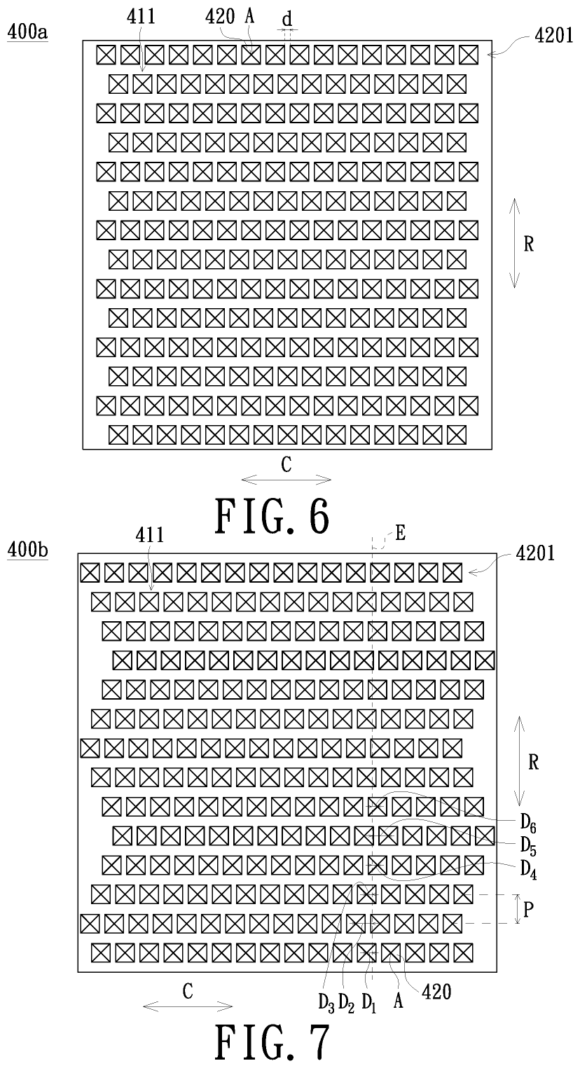

FIG. 7 is a schematic diagram of a reflective sheet according to another embodiment of the invention. The structure and advantages of the reflective sheet 400b of this embodiment are similar to those of the reflective sheet 400, wherein the plurality of pyramidal structures 420 include a plurality of pyramidal structure columns 4201 arranged in parallel along the row direction R, and each pyramidal structure column 4201 has a part of the pyramidal structures 420 (a partial number of the plurality of pyramidal structures 420) arranged along the column direction C, and the row direction R is perpendicular to the column direction C. Only the main differences in structures will be described below. In the reflective sheet 400b of this embodiment, a part of the plurality of pyramidal structures 420 are arranged along a reference line E parallel to the row direction R and exhibit a sinusoidal pattern, which satisfies the formula: D_{N}=c×P×sin(NP/Lα×360°). Specifically, D is the displacement of each pyramidal structure 420 in the part of the pyramidal structures 420 in the direction perpendicular to the reference line E, or can be regarded as the distance between the apex A of the pyramidal structure 420 and the reference line E. c is the displacement amplitude correction coefficient, and 0.5<c<5, wherein c is larger when the displacement D is larger, and c is smaller when the displacement D is smaller. P is the distance from the midpoint of each pyramidal structure column 4201 in the row direction R to the midpoint of another adjacent pyramidal structure column 4201 in the row direction R. N is a positive integer. Lα is a sine periodic coefficient, and the actual distance of Lα is 100 um≤Lα≤1000 um, wherein this distance is also a complete cycle of the sine pattern, and Lα is an integer multiple of P.

Take FIG. 7 as an example to describe the relationship between N and Lα. When six pyramidal structures 420 can complete a complete cycle of a sine pattern, Lα is 6 and N is 1 to 6, which is used to indicate the pyramidal structure 420 at the Nth position. D_{N} is the displacement of the pyramidal structure 420 at the Nth position, for example, D₁ is the displacement of the pyramidal structure 420 at the first position, D₂ is the displacement of the pyramidal structure 420 at the second position, D₃ is the displacement of the pyramidal structure 420 at the third position, D₄ is the displacement of the pyramidal structure 420 at the fourth position, D₅ is the displacement of the pyramidal structure 420 at the fifth position, and D₆ is the pyramidal structure 420 at the sixth position displacement. Under the above design, the arrangement of the plurality of pyramidal structures 420 in the reflective sheet 400b is similar to the arrangement of those in the reflective sheet 400a, but the details are different. In another embodiment of the reflective sheet 400b, the variation exhibited by a part of the plurality of pyramidal structures 420 arranged along the reference line E parallel to the row direction R may be a pattern formed by mixing a sine function and a random number function.

When the above-mentioned plurality of quadrangular pyramid structures 420 arranged in the same and regular array as shown in FIGS. 1 to 5 are used, the distances of the quadrangular pyramid structures 420 are substantially the same or the quadrangular pyramid structures 420 are closely connected in this case. Therefore, when the light source module 10 with a plurality of the same and regular quadrangular pyramid structures 420 is used in a display device, the interference ripples may be generated on the display screen. Thus, by randomly distributing the plurality of pyramidal structures 420 on the reflective surface 411 or by arranging them on the reflective surface 411 in the manner shown in FIGS. 6 and 7, a better display effect is achieved.

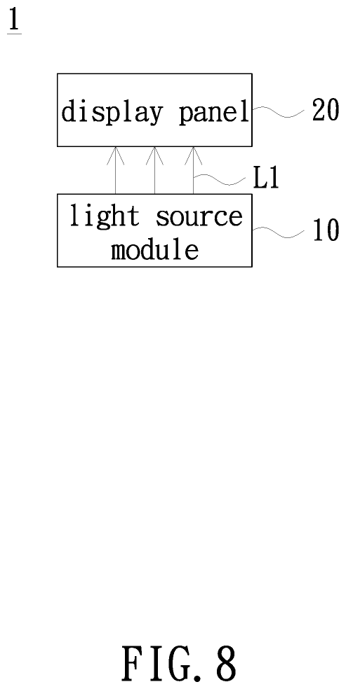

FIG. 8 is a schematic block diagram of a display device according to an embodiment of the invention. Referring to FIG. 8, the display device 1 of this embodiment includes the aforementioned light source module 10 and a display panel 20. The display panel 20 is disposed on the light emitting side of the light source module 10. The display panel 20 may be a liquid crystal display panel or other non-self-luminous display panel. The light source module 10 is configured to provide a surface light source L1 to the display panel 20 as a display light source. The light source module 10 can be replaced with the light source module in any of the above embodiments, or the reflective sheet 400 can be replaced with the reflective sheet in any of the above embodiments. Because the light source module 10 of the display device 1 in this embodiment can adjust the light exit angle of the light to improve the effect of forward light output, the light field energy of the output light can be adjusted to a better light field distribution, thereby improving the brightness uniformity of the display image.

In summary, in the light source module of the embodiment of the invention, the reflective sheet includes a plurality of pyramidal structures, and one of the plurality optical side surfaces of each pyramidal structure faces the light incident surface. Because the optical side surface of the pyramidal structure is inclined relative to the light incident surface, light is reflected back to the light guide plate by the inclined optical side surface when the light exits from the bottom surface and is transmitted to the reflective sheet, wherein the reflection angle is changed by the inclined optical side surface. With the setting of the pyramidal structures, the light exit angle of the light exiting from the light emitting surface can be adjusted. In addition, the prism sheet in the light source module of the embodiment of the invention can further converge and concentrate the adjusted light to form a uniform surface light source. Therefore, compared with the conventional light source module using a reflective sheet without a structure, the light source module of the embodiment of the invention can improve the effect of forward light output. Because the display device of the embodiment of the invention uses the aforementioned light source module, the light field energy of the output light can be adjusted to a better light field distribution, thereby improving the brightness uniformity of the display image.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first optical side surface, the second optical side surface, the third optical side surface, the fourth optical side surface, the first vertex angle, and the second vertex angle are only used for distinguishing various elements and do not limit the number of the elements.

What is claimed is:

1. A light source module, comprising:
a light guide plate, having a light incident surface, a light emitting surface and a bottom surface opposite to the light emitting surface, wherein the light incident surface is connected to the light emitting surface and the bottom surface;
a plurality of light emitting elements, disposed beside the light incident surface and configured to emit light to the light incident surface;
a prism sheet, disposed beside the light emitting surface and comprising a plurality of prism pillars; and
a reflective sheet, disposed beside the bottom surface and comprising:
a substrate, having a reflective surface facing the bottom surface; and
a plurality of pyramidal structures, disposed on the reflective surface, wherein each of the pyramidal structures has a plurality of optical side surfaces, each of the optical side surfaces has a bottom edge, the bottom edge is connected to the reflective surface, one of the optical side surfaces of each of the pyramidal structures faces the light incident surface, and the bottom edge thereof is parallel to the light incident surface.

2. The light source module according to claim 1, wherein the pyramidal structures comprise a plurality of pyramidal structure columns arranged in parallel along a row direction, each of the pyramidal structure columns has a part of the pyramidal structures arranged along a column direction, and the row direction is perpendicular to the column direction.

3. The light source module according to claim 2, wherein each of the pyramidal structures has a vertex, and a midpoint of a distance between any two adjacent pyramidal structures in the pyramidal structures in each of the pyramidal structure columns corresponds to the vertex of one of the pyramidal structures in another adjacent pyramidal structure column.

4. The light source module according to claim 2, wherein the part of the pyramidal structures are arranged along a reference line parallel to the row direction and exhibit a sinusoidal pattern, which satisfies a formula: D_{N}=c×P×sin(NP/Lα×360°), wherein D is a displacement of each of the pyramidal structures in a direction perpendicular to the reference line; c is a displacement amplitude correction coefficient, and 0.5<c<5; P is a distance from a midpoint of each of the pyramidal structure columns in the row direction to the midpoint of the another adjacent pyramidal structure column in the row direction; and N is a positive integer; Lα is a sine periodic coefficient, 100 um≤Lα≤1000 um, and Lα is an integer multiple of P.

5. The light source module according to claim 1, wherein there is a distance between any two adjacent pyramidal structures in the pyramidal structures.

6. The light source module according to claim 1, wherein any two adjacent pyramidal structures in the pyramidal structures are connected to each other.

7. The light source module according to claim 1, wherein each of the pyramidal structures is a quadrangular pyramid structure, the optical side surfaces comprise a first optical side surface, a second optical side surface, a third optical side surface and a fourth optical side surface, the first optical side surface is opposite to the third optical side surface, the second optical side surface is opposite to the fourth optical side surface, and the bottom edge of the first optical side surface is parallel to the light incident surface.

8. The light source module according to claim 7, wherein each of the optical side surfaces has a vertex angle, and an angular range of the vertex angle is 90° to 150°.

9. The light source module according to claim 7, wherein the first optical side surface and the third optical side surface each have a first vertex angle, the second optical side surface and the fourth optical side surface each have a second vertex angle, an angular range of the first vertex angle is 5° to 175°, and an angular range of the second vertex angle is 5° to 175°.

10. The light source module according to claim 1, wherein the prism pillars face the light emitting surface, each of the prism pillars has a prism vertex angle, an angular range of the prism vertex angle is 75° to 85°, each of the optical side surfaces has a vertex angle, and an angular range of the vertex angle is 70° to 170°.

11. The light source module according to claim 1, wherein the prism pillars face the light emitting surface, each of the prism pillars has a prism vertex angle, an angular range of the prism vertex angle is 150° to 170°, each of the optical side surfaces has a vertex angle, and an angular range of the vertex angle is 95° to 160°.

12. The light source module according to claim 1, wherein the pyramidal structures are light-transmitting.

13. The light source module according to claim 1, wherein the pyramidal structures are made of a light reflective material.

14. The light source module according to claim 1, wherein each of the pyramidal structures further has an apex, and a shape of the apex comprises a point shape, a plane shape and an arc shape.

15. The light source module according to claim 1, wherein any two adjacent optical side surfaces of the optical side surfaces are connected to each other to form a ridgeline of each of the pyramidal structures, and a shape of the ridgeline comprises a line shape, a plane shape and an arc shape.

16. The light source module according to claim 1, wherein at least a part of the pyramidal structures have different heights in a direction perpendicular to the reflective surface.

17. The light source module according to claim 1, further comprising an optical film set disposed beside the light emitting surface, wherein the optical film set comprises at least one optical film.

18. A display device, comprising:
a light source module, comprising:
a light guide plate, having a light incident surface, a light emitting surface and a bottom surface opposite to the light emitting surface, wherein the light incident surface is connected to the light emitting surface and the bottom surface;
a plurality of light emitting elements, disposed beside the light incident surface and configured to emit light to the light incident surface;
a prism sheet, disposed beside the light emitting surface and comprising a plurality of prism pillars; and
a reflective sheet, disposed beside the bottom surface and comprising:
a substrate, having a reflective surface facing the bottom surface; and
a plurality of pyramidal structures, disposed on the reflective surface, wherein each of the pyramidal structures has a plurality of optical side surfaces, each of the optical side surfaces has a bottom edge, the bottom edge is connected to the reflective surface, one of the optical side surfaces of each of the pyramidal structures faces the light incident surface, and the bottom edge thereof is parallel to the light incident surface; and
a display panel, disposed on a light emitting side of the light source module.
